(19) United States
(12) Patent Application Publication
(10) Pub. No.: US 2025/0109274 A1
(43) Pub. Date: Apr. 3, 2025

(54) BIODEGRADABLE CONSTRUCTION MATERIAL

(71) Applicant: K&M International, LLC, Independence, OH (US)

(72) Inventors: G.B. PILLAI, Independence, OH (US); Vishnu CHANDRAN, Independence, OH (US)

(73) Assignee: K&M International, LLC, Independence, OH (US)

(21) Appl. No.: 18/901,651

(22) Filed: Sep. 30, 2024

Related U.S. Application Data
(60) Provisional application No. 63/541,534, filed on Sep. 29, 2023.

(51) Int. Cl. C08K 5/1545; C08J 3/20

(52) U.S. Cl. CPC C08K 5/1545; C08J 3/20; C08K 2201/014; C08K 2201/018

(57) ABSTRACT

A construction material, including a base plastic and an additive configured to encourage microorganisms to chemically break down the base plastic, the additive having a concentration between about 0.5% and about 1% by weight.

### CROSS-REFERENCE TO RELATED APPLICATIONS

This application claims priority under 35 U.S.C. § 120 from U.S. Provisional application No. 63/541,534, filed on Sep. 29, 2023 in the United States Patent and Trademark Office, the disclosure of which is incorporated herein in its entirety by reference.

### BACKGROUND

Children's toys and many other items are commonly made of plastic, allowing for mass production and resilient, lightweight construction. However, this same plastic is extremely slow to naturally decompose. Microorganisms typically responsible for biodegradation have difficulty processing the complicated polymers of plastics, meaning that it can take decades or centuries for plastics to break down. As a result, discarded plastic toys are taking up more and more space in landfills.

There is therefore a need for a biodegradable construction material that can be used in place of conventional plastic.

### SUMMARY OF THE INVENTION

Exemplary embodiments of the present general inventive concept provide a biodegradable construction material and methods of manufacturing the same.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a construction material including a base plastic, and an additive configured to encourage microorganisms to chemically break down the base plastic, the additive having a concentration between about 0.5% and about 1% by weight.

In an embodiment, the base plastic may include a polymer molecular structure, and the additive may encourage production of enzymes that break down the polymer molecular structure of the base plastic.

In an embodiment, the additive may encourage anaerobic biodegradation of the base plastic.

In an embodiment, the additive may be made of one or more of aliphatic aromatic vinegar, aldose or aldohexose, monosaccharide, and polysaccharide.

In an embodiment, the additive may be made of about 32% aliphatic aromatic vinegar, about 27% aldose or aldohexose, about 20% monosaccharide, and about 21% polysaccharide by weight.

The foregoing and/or other features and utilities of the present general inventive concept may be achieved by providing a method of making a construction material, the method including providing a base plastic, and adding an additive to the base plastic at a concentration between about 0.5% and about 1% by weight, the additive being configured to encourage microorganisms to chemically break down the base plastic.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 illustrates parts made with a construction material according to exemplary embodiments of the present general inventive concept.

FIG. 2 is a graph of biodegradation of a test sample of a construction material according to an exemplary embodiment of the present general inventive concept;

FIG. 3 is a graph of emission of biogas due to biodegradation of a test sample of a construction material according to an exemplary embodiment of the present general inventive concept;

FIGS. 4A-4B illustrate microscopic views of a test sample of a construction material prior to biodegradation according to an exemplary embodiment of the present general inventive concept; and

FIGS. 4C-4D illustrate microscopic views of a test sample of a construction material during biodegradation according to an exemplary embodiment of the present general inventive concept.

### DETAILED DESCRIPTION OF EXEMPLARY EMBODIMENTS OF THE INVENTIVE CONCEPT

Reference will now be made in detail to embodiments of the present general inventive concept, examples of which are illustrated in the accompanying drawings, wherein like reference numerals refer to the like elements throughout. The embodiments are described below in order to explain the present general inventive concept while referring to the figures. Also, while describing the present general inventive concept, detailed descriptions about related well-known functions or configurations that may diminish the clarity of the points of the present general inventive concept are omitted.

Expressions such as “at least one of,” when preceding a list of elements, modify the entire list of elements and do not modify the individual elements of the list.

All terms including descriptive or technical terms which are used herein should be construed as having meanings that are obvious to one of ordinary skill in the art. However, the terms may have different meanings according to an intention of one of ordinary skill in the art, case precedents, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

Also, when a part “includes” or “comprises” an element, unless there is a particular description contrary thereto, the part can further include other elements, not excluding the other elements.

Hereinafter, one or more exemplary embodiments of the present general inventive concept will be described in detail with reference to accompanying drawings.

Exemplary embodiments of the present general inventive concept provide a biodegradable construction material. This construction material may include a base plastic having a polymer molecular structure. According to exemplary embodiments of the present general inventive concept, the base plastic may be Acrylonitrile Butadiene Styrene, or “ABS,” plastic. The biodegradable construction material may further include an additive which may be added to the base plastic while it is being produced or while it is being formed into a product, e.g., molded or cast into a final shape. According to exemplary embodiments of the present general inventive concept, the construction material may include a concentration of the additive by weight between about 0.5% and about 1%.

The additive may render the construction material biodegradable by encouraging microorganisms to chemically break down the base plastic. More specifically, the additive may chemically change the base plastic to encourage microorganisms to break it down. According to exemplary embodiments of the present general inventive concept, the additive may encourage naturally-occurring microorganisms to produce enzymes that break up a polymer chain in the base plastic into smaller pieces. For example, the additive may encourage the production of enzymes that break down a polymer molecular structure of ABS into its component monomers of acrylonitrile, butadiene, and styrene, which are chemically simpler and therefore easier to break down further by natural degradation. After the enzymes have broken down the polymer of the base plastic in this way, the resulting simpler compounds may be more directly processed by microorganisms, for example by removing carbon from the molecular structures. This processing, of enzymes breaking down the polymer and microorganisms breaking down the resultant monomers, may break down the overall structural integrity of the base plastic, causing the construction material according to exemplary embodiments of the present general inventive concept to fall apart and decompose over time. According to exemplary embodiments of the present general inventive process, the additive may encourage anaerobic biodegradation of the base plastic, meaning decomposition may occur without the use of oxygen. The biodegradation process may generate carbon dioxide and methane as by-products of breaking down the polymer molecular structure of the base plastic.

According to an exemplary embodiment of the present general inventive concept, the additive may be based on the principles of Reversebioinspired Chem otaxis and Quorumsensing of insect intestines. The additive may be composed of, among other things, aliphatic aromatic vinegar, aldose or aldohexose, monosaccharide, and polysaccharide. According to an exemplary embodiment of the present general inventive concept, the components of the additive may be about 32% aliphatic aromatic vinegar, about 27% aldose or aldohexose, about 20% monosaccharide, and about 21% polysaccharide by weight. It will be understood that this is a non-limiting example, and the additive may have any composition that encourages biodegradation in the base plastic.

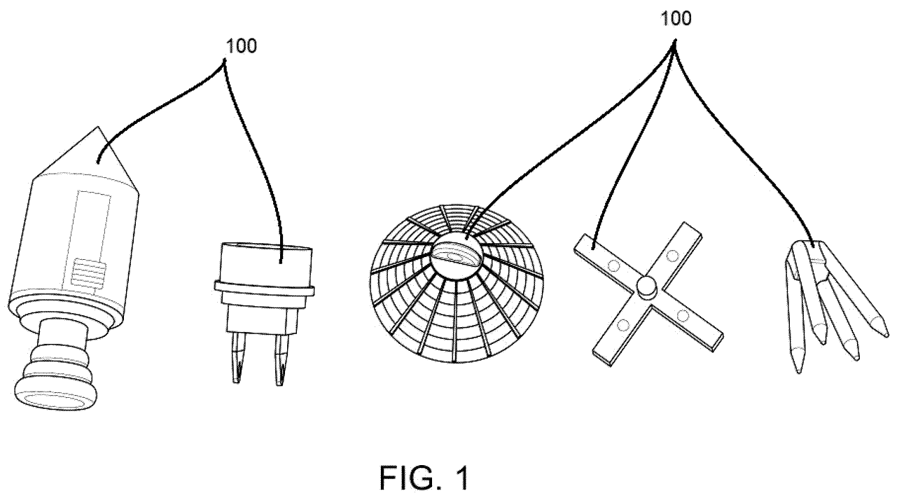

At concentrations below about 0.5% by weight, the additive may not appreciably affect decomposition or biodegradation of the base plastic. At concentrations above about 1% by weight, the additive may structurally weaken the base plastic. If the additive is at a concentration between about 0.5% and about 1% by weight, then a construction material according to exemplary embodiments of the present general inventive concept may be structurally similar to the base plastic, for example ABS, and may therefore be used for any construction or purpose the base plastic could be used for. According to exemplary embodiments of the present general inventive concept, the construction material may be used to craft toys, which may include one or more moving parts and may be made in different sizes. FIG. 1 illustrates non-limiting examples of pieces which may be made with the construction material 100 according to exemplary embodiments of the present general inventive concept.

### Example 1

A test sample of a construction material according to an exemplary embodiment of the present general inventive concept was prepared including a 1% concentration by weight of the additive added to the base plastic. The test sample was tested under a method designed to convert carbon in the test sample to carbon in a gaseous form under conditions found in high-solids anaerobic digesters, treating municipal solid waste.

The test sample of construction material was mixed with an inoculum derived from anaerobic digested sewage sludge, at a ratio by weight of 1000 g inoculum to 15 to 100 g of construction material. The inoculum had a measured pH of 7.8. The inoculum included 44% dry solids.

The test sample of construction material mixed with the inoculum was tested at a temperature of 52 degrees Celsius in the dark or in diffused light. The test sample was tested for decomposition and gas emission. The test sample was also tested alongside two controls: a base control composed of just the inoculum, and a “positive control,” including both the inoculum and a cellulose material which may degrade naturally at a predictable rate.

The emission of biogas, or gas including carbon, indicates decomposition or biodegradation. Biogas may include methane and carbon dioxide, which may be emitted by bacteria breaking down a material, especially in an anerobic reaction. Over a period of 45 days in this test, the test sample of the construction material emitted 4050 ml of biogas. In comparison, the positive control of cellulose emitted 9540 ml of biogas, and the base control of the inoculum emitted 2960 ml of biogas.

The percent biodegradation of the positive control and the test sample of construction material were calculated by the measured cumulative carbon dioxide and methane production, after subtracting carbon dioxide evolution and methane evolution from the base control of inoculum. Calculations were based on total organic carbon obtained from both the positive control and the test sample of construction material. Percent weight loss was based on the initial weight and final weight of the test sample after the test. At the end of 45 days the test sample of construction material showed a biodegradation of 5.39%, and a weight loss of 1.42%. In comparison, the positive control showed a biodegradation of 90.96% under similar conditions.

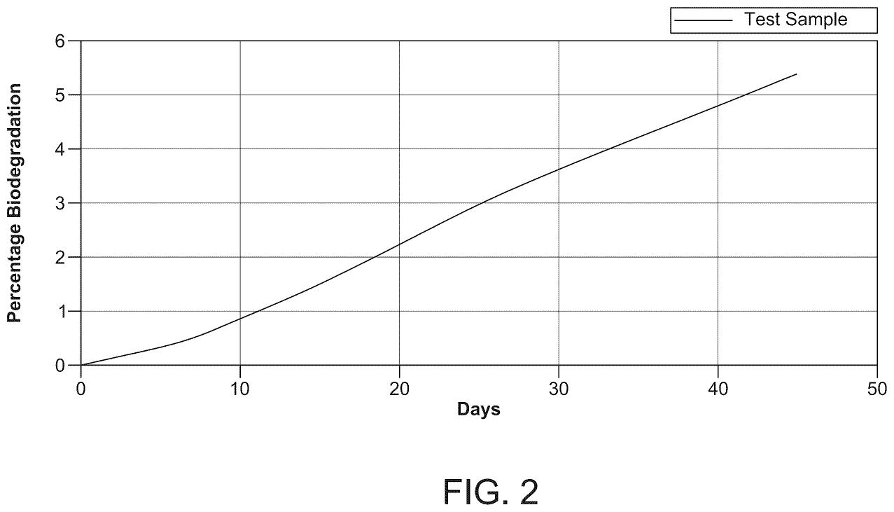

The results of the testing in Example 1 are shown more particularly in FIGS. 2, 3, and 4A-4D. FIG. 2 is a graph illustrating the rate of biodegradation of the test sample prepared according to an exemplary embodiment of the present general inventive concept. As illustrated therein, biodegradation progressed steadily over time. In comparison, plastic such as ABS without an additive would remain substantially unchanged over time, taking centuries to break down naturally.

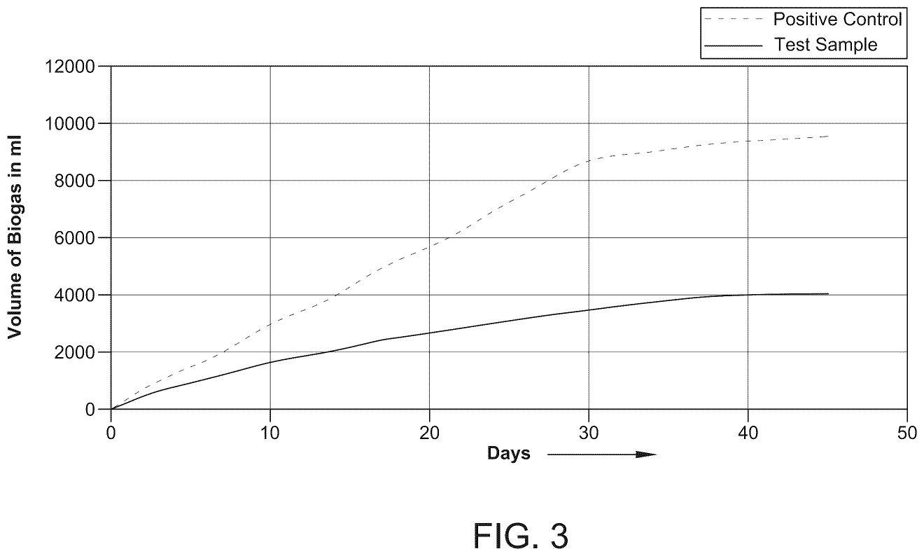

FIG. 3 is a graph illustrating an emission of biogas from the test sample of construction material in comparison to the positive control sample of cellulose, which breaks down more readily than conventional plastic. The test sample is shown on the graph as a solid line, and the positive control is shown on the graph as a dashed line. As illustrated in FIG. 3, biogas was emitted from the test sample of construction material for over 40 days, indicating biodegradation was ongoing during that time.

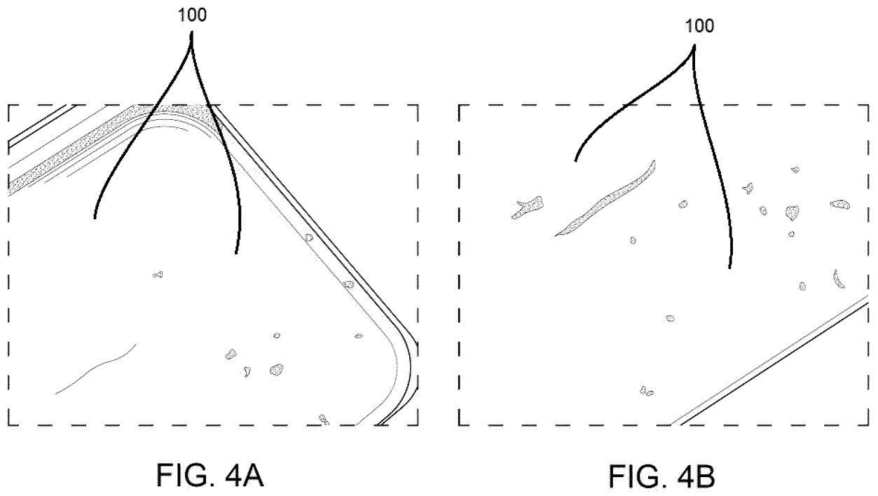

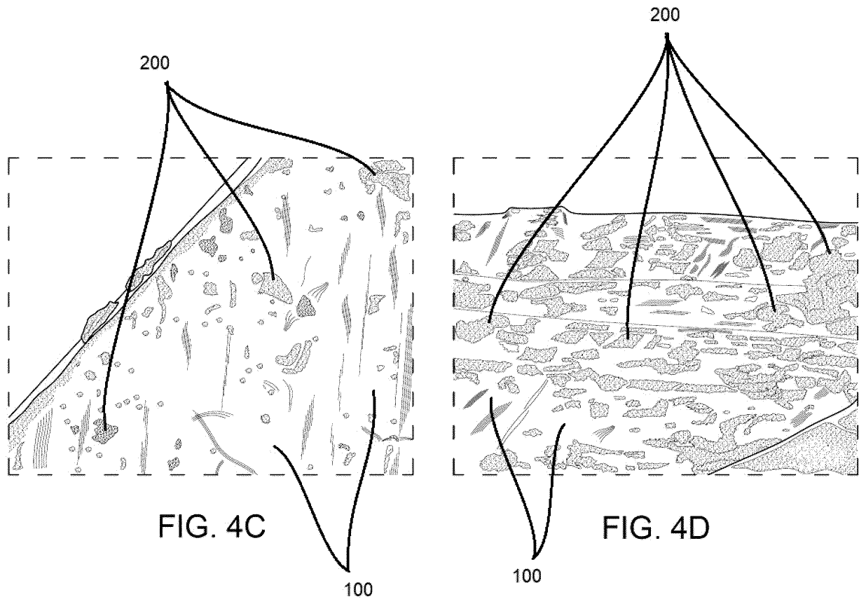

FIGS. 4A and 4B illustrate microscopic views of the construction material 100 during testing. The sample illustrated in FIGS. 4A and 4B has not yet undergone a biodegradation process. In comparison, FIGS. 4C and 4D illustrate microscopic views of the construction material 100 after enough time has passed that biodegradation has begun. The discoloration and spots 200 on the material in FIGS. 4C-4D are evidence that biodegradation is ongoing. FIGS. 4C-4D illustrate the level of biodegradation in the test sample of construction material 100 after about 45 days.

### Example 2

Another sample of a construction material according to an exemplary embodiment of the present general inventive concept was tested. The construction material was comprised of ABS as a base plastic, with 1% of the additive by weight.

The test proceeded similarly to Example 1, with similar samples being tested, including a base control of the inoculum and a positive control of a cellulose material. The inoculum had a measured pH of 7.85 and included 44% dry solids.

Over a period of 45 days the test sample of construction material emitted 4500 ml of biogas. In comparison the positive control of cellulose emitted 9200 ml of biogas, and the base of the inoculum emitted 2540 ml. At the end of 45 days the test sample of construction material showed a biodegradation of 5.27%, and a weight loss of 1.27%. In comparison, the positive control showed biodegradation of 92.18% under similar conditions.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A construction material, comprising:
a base plastic; and
an additive configured to encourage microorganisms to chemically break down the base plastic, the additive having a concentration between about 0.5% and about 1% by weight.

2. The construction material of claim 1, wherein the base plastic includes a polymer molecular structure, and
wherein the additive encourages production of enzymes that break down the polymer molecular structure of the base plastic.

3. The construction material of claim 1, wherein the additive encourages anaerobic biodegradation of the base plastic.

4. The construction material of claim 1, wherein the additive is comprised of one or more of aliphatic aromatic vinegar, aldose or aldohexose, monosaccharide, and polysaccharide.

5. The construction material of claim 4, wherein the additive is comprised of about 32% aliphatic aromatic vinegar, about 27% aldose or aldohexose, about 20% monosaccharide, and about 21% polysaccharide by weight.

6. A method of making a construction material, the method comprising:
providing a base plastic; and
adding an additive to the base plastic at a concentration between about 0.5% and about 1% by weight, the additive being configured to encourage microorganisms to chemically break down the base plastic.
